(19) United States
(12) Patent Application Publication
(10) Pub. No.: US 2013/0060627 A1
(43) Pub. Date: Mar. 7, 2013

(54) PROXIMITY-DEPENDENT SHOPPING OFFER

(71) Applicant: Joshua C. Harrison, Kirkland, WA (US)

(72) Inventor: Joshua C. Harrison, Kirkland, WA (US)

(73) Assignee: Microsoft Corporation, Redmond, WA (US)

(21) Appl. No.: 13/224,242

(22) Filed: Sep. 1, 2011

(51) Int. Cl. G06Q 30/00

(52) U.S. Cl. 705/14.39; 705/14.58; 705/14.53; 705/14.54

(57) ABSTRACT

This document describes techniques and apparatuses enabling a proximity-dependent shopping offer. In some embodiments, the techniques determine, based on information about a user of a mobile device, that the user is likely to be interested in a particular product. The techniques may also determine that the user is conveniently near to a store at which to purchase the product. By so doing, the techniques enable stores to target offers to a person that is likely to be interested in visiting the store.

### BACKGROUND

Currently, when a store wants to bring in customers, the store advertises. The store may advertise a particular product likely to generate customer interest or a sale, usually covering many products.

Conventional advertisements, however, often fail to target likely customers. Instead, these conventional advertisements are received by many people that are not interested. In some cases these people are not interested in the particular product or in the store generally. In some other cases, the people are not interested because the advertisement comes to them at an inconvenient time.

### SUMMARY

This document describes techniques and apparatuses enabling a proximity-dependent shopping offer. In some embodiments, the techniques determine, based on information about a user of a mobile device, that the user is likely to be interested in a particular product. The techniques may also determine that the user is conveniently near to a store at which to purchase the product. By so doing, the techniques enable stores to target offers to a person that is likely to be interested in visiting the store.

This summary is provided to introduce simplified concepts enabling a proximity-dependent shopping offer, which is further described below in the Detailed Description. This summary is not intended to identify essential features of the claimed subject matter, nor is it intended for use in determining the scope of the claimed subject matter. Techniques and/or apparatuses enabling a proximity-dependent shopping offer are also referred to herein separately or in conjunction as the “techniques” as permitted by the context.

### BRIEF DESCRIPTION OF THE DRAWINGS

Embodiments of techniques enabling proximity-dependent shopping offers are described with reference to the following drawings. The same numbers are used throughout the drawings to reference like features and components:

FIG. 1 illustrates an example environment in which techniques enabling a proximity-dependent shopping offer can be implemented.

FIG. 2 is a more-detailed illustration of mobile computing devices illustrated in FIG. 1.

FIG. 3 is a more-detailed illustration of the remote device of FIG. 1.

FIG. 4 illustrates an example method enabling proximity-dependent shopping offers from the perspective of one or more entities operating at a mobile device.

FIG. 5 illustrates a user interface of a tablet computing device having a proximity-dependent shopping offer.

FIG. 6 illustrates an example method enabling proximity-dependent shopping offers from the perspective of one or more entities operating at a remote device.

FIG. 7 illustrates an example device in which techniques enabling a proximity-dependent shopping offer can be implemented.

### DETAILED DESCRIPTION

Overview

With information about a user of a mobile device, the techniques can target and tailor a proximity-dependent shopping offer to the user, including at a time and location convenient to the user. Further, an offer can be for a product that the user has indicated, directly or indirectly, to be of interest, such as by the user searching on her mobile device for the product or because the user has a habit of buying similar products. Thus, the techniques can enable stores to better sell their products and also users to conveniently find and purchase desired products.

Assume, for example, that a coffee shop would like to introduce a new iced coffee drink The coffee shop may put advertisements on radio, television, in newspapers and magazines, on billboards, or on its website. In each of these cases, however, the cost of the advertisements can be high, poorly targeted to likely customers, or ineffective at reaching likely customers. Contrast these conventional advertisements, however, with an example way in which the techniques may operate.

Assume instead that the techniques determine that a user of a mobile device has a history of buying iced coffee drinks, is walking down a street about one block from passing directly next to the coffee shop, and that current weather conditions indicate that it is relatively warm outside. With this information, the techniques may present a proximity-dependent shopping offer through the user's mobile device, such as a coupon for twenty-percent off the new iced coffee drink Further, the techniques may work with an entity associated with the coffee shop to present this shopping offer. Assume that the coffee shop is very slow at the current time of day, and thus the entity authorizes instead a fifty-percent-off coupon for the new iced coffee drink.

This is but one example of how techniques enabling proximity-dependent shopping offers can operate. This document now turns to an example environment in which the techniques can be embodied, after which various example methods for performing the techniques are described, and concludes with an example apparatus.

Example Environment

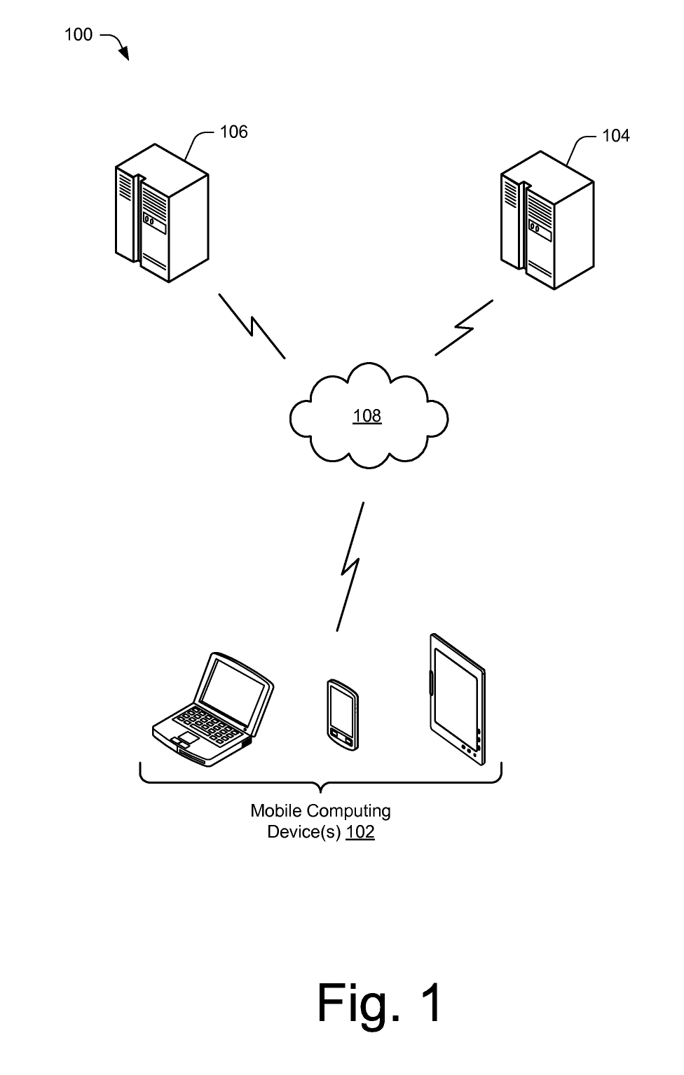

FIG. 1 is an illustration of an example environment 100 in which the techniques may provide proximity-dependent shopping offers. Environment 100 includes one or more mobile computing device(s) 102, a remote device 104, a third-party remote device 106, and a communication network 108. Mobile computing device 102 includes information about the user, such as the user's interests, habits, and current location. Mobile computing device 102 also presents proximity-dependent shopping offers to the user as described in more detail below.

Mobile computing device 102 may perform operations alone or in conjunction with other device(s), such as remote device 104 or third-party remote device 106. Mobile computing devices 102, remote device 104, and third-party remote device 106 interact through communication network 108, which may be the Internet, a local-area network, a wide-area network, a wireless network, a cellular network, a USB hub, a computer bus, or a combination of these.

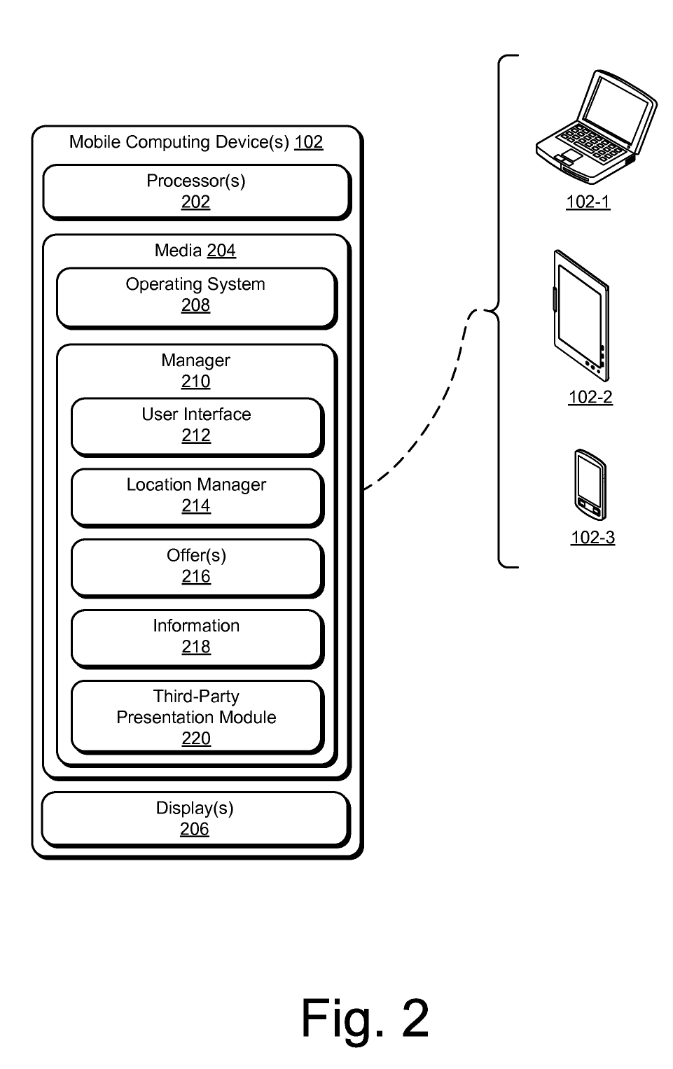

FIG. 2 is an illustration of an example embodiment of mobile computing device 102. Mobile computing device 102 includes one or more processors 202, computer-readable storage media (“media”) 204, and display(s) 206. Media 204 includes an operating system 208 and manager 210. Manager 210 includes or has access to one or more of a user interface 212, a location manager 214, one or more offers 216, information 218, and/or, in some cases, third-party presentation module 220.

Manager 210 manages proximity-dependent shopping offers either alone or in combination with other entities described herein. User interface 212, shown included in manager 210, presents offers to a user, such as with an audio or visual indicator, email, text message, or pop-up window, to name just a few. Location manager 214 aids in determining the geographic location of mobile device 102. Offers 216 include one or more offers for presentation through mobile device 102, assuming that various conditions are met.

Information 218 includes current and historical data about mobile device 102 and its user, such as search terms (e.g., “Pink children's ballet shoes”), purchases (date, type, name of store, Internet only or brick-and-mortar, manner of purchase), selected products (e.g., items or services selected to be viewed or about which to received additional information), demographical data (user's age and gender, etc.), geographical location (including speed and time), wish lists of products entered by the user, shopping carts (whether purchased on not), electronic coupons redeemed (e.g., prior coupons offered and used as part of a proximity-dependent shopping offer), technical specifications of mobile device 102, peripheral devices (e.g., speakers for a tablet mobile device), and applications installed or used on the mobile device.

As shown in FIG. 2, mobile computing device(s) 102 can each be one or a combination of various computing devices, here illustrated with three examples: a laptop computer 102-1, a tablet computer 102-2, and a smart phone 102-3, though other computing devices and systems, such as netbooks and cellular phones, may also be used.

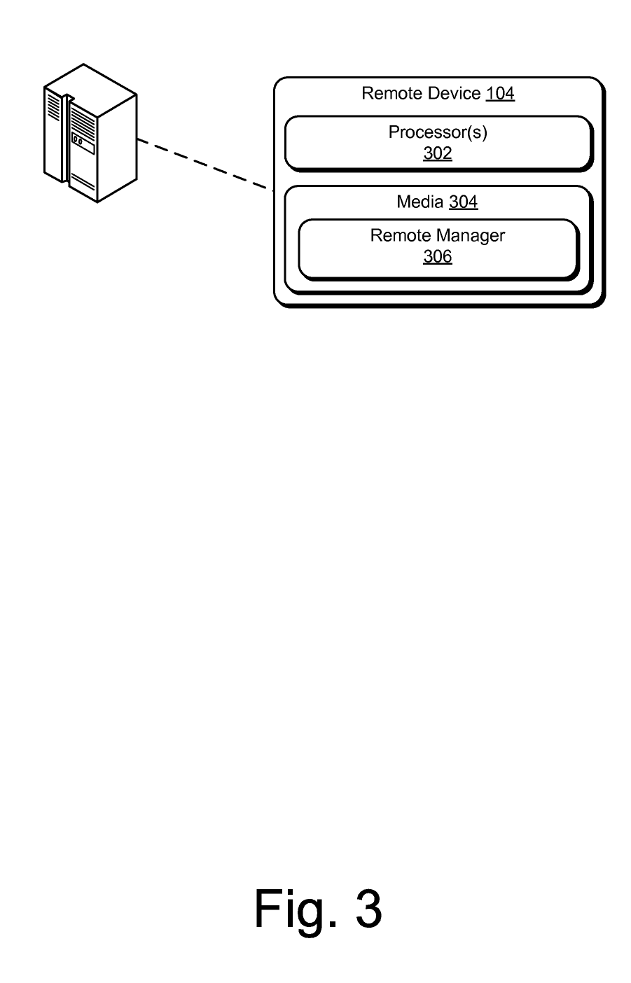

FIG. 3 is an illustration of an example embodiment of remote device 104. Remote device 104 includes one or more remote processors 302 and remote computer-readable storage media (“remote media”) 304. Media 304 includes or has access to a remote manager 306. Remote manager 306 manages proximity-dependent shopping offers either alone or in combination with other entities described herein. Remote manager 306 may include or have access to entities similar or identical to location manager 214, offer(s) 216, and information 218. Like manager 210, remote manager 306 may cause mobile device 102 to notify a user through user interface 212. For example, remote manager 306 may send a text, email, or markup-language document to mobile device 102 in response to which mobile device 102 notifies the user through user interface 212, such as through presenting the text message or email, or rendering the markup-language document as hyper-text machine language, to name just a few examples.

Mobile device 102 and remote device 104 may work in conjunction with third-party remote device 106, though this is not required. Third-party remote device(s) 106 (not illustrated in detail) can be associated with various brick-and-mortar stores and provide particular offers or authorize offers of certain types, such as when a particular chain of stores (e.g., CoffeeBucks) manages its offers through computer servers. In many cases, however, offers available at various stores are stored at remote device 104 and managed by remote manager 306 with little or no interaction with third-party remote devices 106.

These and other capabilities, as well as ways in which entities of FIGS. 1-3 act and interact, are set forth in greater detail below. Note also that these entities may be further divided, combined, and so on. Thus, the environment 100 of FIG. 1 and the detailed illustrations of FIGS. 2 and 3 illustrate some of many possible environments capable of employing the described techniques.

Example Methods

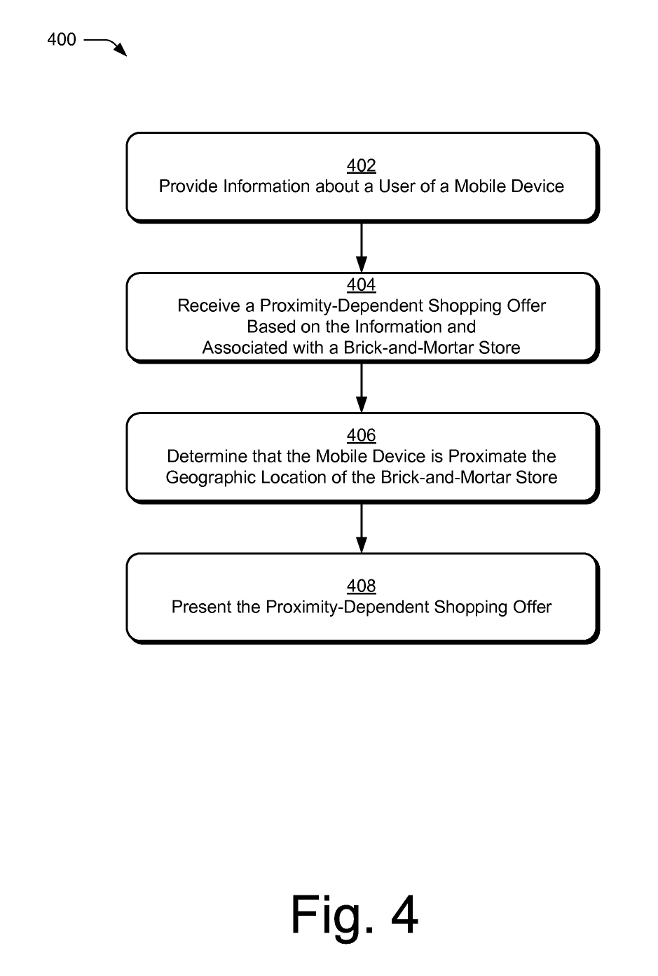

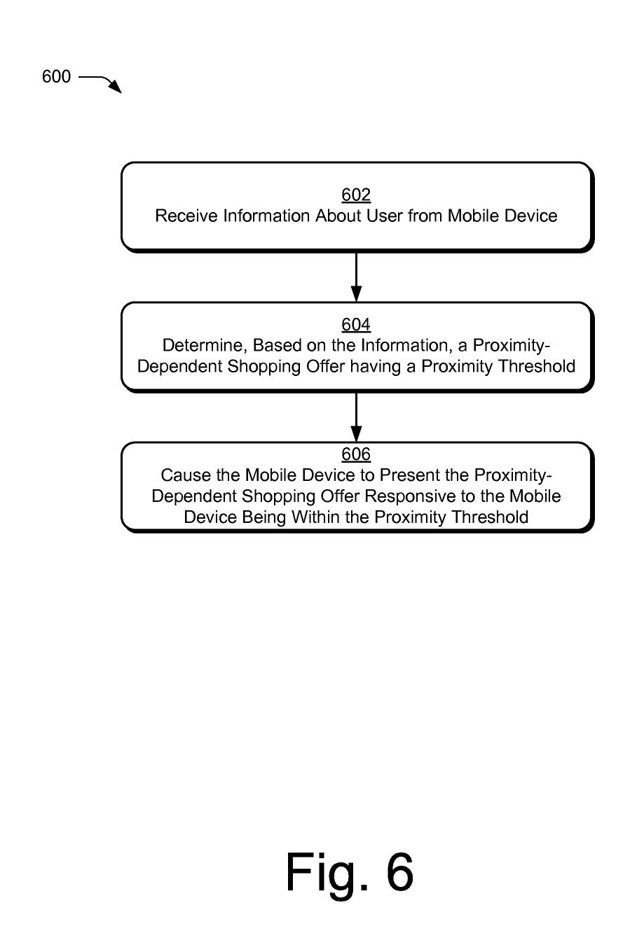

FIGS. 4 and 6 depict example methods enabling a proximity-dependent shopping offer. FIG. 4 depicts a method from the perspective of one or more entities operating at mobile device 102. FIG. 6 depicts a method from the perspective of an entity operating on remote device 104. The techniques are not limited to performance by one entity or multiple entities operating on one device. These methods are shown as sets of blocks that specify operations performed but are not necessarily limited to the order shown for performing the operations by the respective blocks. In portions of the following discussion reference may be made to environment 100 of FIG. 1 and as detailed in FIGS. 2-3, reference to which is made for example only.

Block 402 provides information, to a remote entity and through a communication network, about a user of a mobile device. As noted above, this information can include the mobile device's current location, historical locations data (e.g., where the device has been and when), search terms and purchases made by the user of the device, and so forth. This information can be provided to various entities, such as remote device 104 or third-party remote device 106, either of which may use this information to determine a proximity-dependent shopping offer as noted below.

Consider, for example, a case where a user searches the Internet, through mobile device 102, for a thumb drive memory device. Manager 210, on mobile device 102, provides the search terms (“best thumb drives”) as well as current and historical location data to remote manager 306 of remote device 104. Manager 210 may provide this information with or without an explicit request from the user. A user may set her mobile device settings to permit her searches and location data to be used to provide offers, after which offers are provided without an explicit request.

Block 404 receives a proximity-dependent shopping offer determined based on the information about the user, the proximity-dependent shopping offer associated with a brick-and-mortar store having a geographic location. This proximity dependence may be temporal or geographic or both.

Continuing the ongoing example, assume that manager 306 of remote device 104 transmits numerous proximity-dependent shopping offers, each of the offers related to thumb drives, brick-and-mortar stores in the city where the user is currently located and at which thumb drives can be purchased, and having a proximity threshold. Each of the brick-and-mortar stores has a location and a geographical proximity threshold around the location, such as a circle with a two-mile diameter surrounding each brick-and-mortar store.

Block 406 determines that the mobile device is proximate the geographical location of the brick-and-mortar store. As noted above, the proximity can be temporal and/or geographic. If only geographic, manager 210 determines that computing device 102 is proximate the geographic location based on a current location of mobile device 102. This can be performed in conjunction with location manager 214 of FIG. 2, and be based on cellular triangulation, global positioning satellites, or in other manners. In the ongoing example, manager 210 determines which, if any, of the brick-and-mortar stores mobile device 102 is within the two-mile diameter geographic proximity threshold.

In some cases, however, the shopping offer includes a temporal proximity threshold. In still other cases, even without the offer explicitly including the temporal proximity, the techniques base whether or not to present the offer on temporal proximity.

Altering the ongoing example, assume that some of the proximity-dependent shopping offers include a five-minute threshold. In such a case, manager 210 determines which of the brick-and-mortar stores are within five minutes based on information about the mobile device. Assume here that the user is walking downtown, which manager 210 determines based on a speed of mobile device 102 calculated based on recently-received location data and an internal clock. With this determined, manager 210 refrains from considering a brick-and-mortar store as being proximate that is about one mile away and instead considers proximate those within a five-minute walk. This can be thought of as an alteration to the geographic proximity threshold from one mile to a couple city blocks or as an additional criteria.

Similarly, manager 210 may determine that the user is driving, and thus that he or she may more quickly reach the brick-and-mortar store. Manager 210 may determine this based on current speed, though manager 210 may also base this determination on an expected travel time to the brick-and-mortar store based on traffic conditions. Manager 210 may refrain from considering the user as proximate to the store if traffic around the store is stop-and-go, for example.

By way of further example, manager 210 may refrain from determining the user to be proximate based on a temporal dependence or other condition. For example, a particular brick-and-mortar store may not be open (e.g., the store's business hours are 9 am to 6 pm and it is currently 6:30 pm).

Block 408 presents, at the mobile device and responsive to determining that the mobile device is proximate the geographical location, the proximity-dependent shopping offer. In some cases manager 210 presents the offer through user interface 212, while in others manager 210 passes the offer to third-party presentation module 220 after determining that the offer is associated with module 220. Third-party presentation modules 220 can be pre-installed or installed by the user, such as in cases where the user likes the particular business (e.g., CoffeeBucks). In either case manager 210 causes the offer to be presented, though with module 220 the offer may be visually more tailored to the business (e.g., the business's coloring, trademarks, and the like).

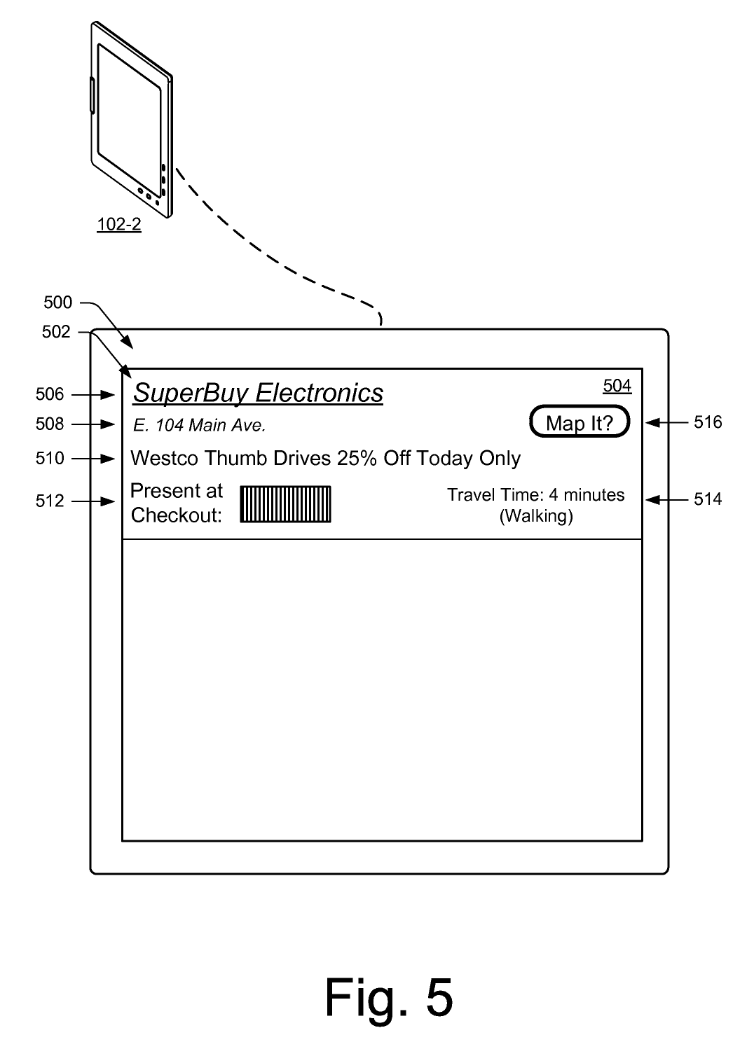

Concluding the ongoing example, consider FIG. 5, which presents user interface 500 of tablet computing device 102-2 having proximity-dependent shopping offer 502 in offer region 504. Note that the offer indicates the business name at 506, its location at 508, a product at 510, an electronic coupon at 512 (redeemable using an electronic reader at the store or visually to a customer service person), and an estimated travel time (calculated as above) at 514, and a mapping selection option 516 to present directions to the store.

While the above-described method involves a remote entity, rather than entities just on a mobile device, this is not required. In some cases, manager 210 interacts only (or primarily) with a local application, such as third-party presentation module 220. Consider a case where a user installs an application to receive offers from a small winery in his home town. The application (one of modules 220) already includes offers for the next year, which are triggered when manager 210 determines proximity. Thus, manager 210 may interact with this module 220 to show a shopping offer for a free wine tasting and appetizers whenever mobile device 102 is within five miles of the winery on Fridays between 3 pm and 7 pm.

As noted above, method 400 is described from the perspective of mobile device 102. This discussion now turns to method 600 of FIG. 6, which is described from the perspective of remote device 104. Ways in which operations are performed in method 600 may be applied to the techniques generally and to operations of method 400. Furthermore, methods 400 and 600 may operate separately or in conjunction, in whole or in part.

Block 602 receives, from a mobile device associated with a user, information about the user. This information may include any of the information described herein, and can be provided as set out in block 402.

By way of example, consider a user with a history of visiting coffee shops between 7 am and 11 am Monday through Friday. This can be known based on tracking of mobile device 102 or purchase records recorded or accessible by remote manager 306. Assume for this example that the information received from mobile device 102 indicates this history and also a current time of 9:15 am on a Tuesday and that the user is driving at a particular speed on a particular road.

Block 604 determines, based on the information about the user, a proximity-dependent shopping offer, the proximity-dependent shopping offer associated with one or more geographic locations having proximity thresholds. Remote manager 306 may determine offers and provide only those that the user is about to, or is already within, an appropriate proximity threshold. Remote manager 306, however, may instead provide many determined offers in which mobile device 102 may or not be within a proximity threshold, instead leaving manager 210 to determine its proximity and whether to present the offer.

Further, in determining the offers, remote manager 306 may interact with other entities, such as third-party remote device 106. In so doing, remote manager 306 may pass the information to third parties, such as remote devices associated with brick-and-mortar stores, and then receives various offers. Remote manager 306 may then analyze these offers and provide some or all of them, such as those that are for brick-and-mortar stores near to mobile device 102.

Continuing the example, assume that remote manager 306 determines many offers and, prior to providing these offers, that mobile device 102 is within a proximity threshold of two such offers, both for coffee shops. One proximity-dependent shopping offer is from a small, private coffee shop offering all drinks for $2.00. The other proximity-dependent shopping offer is from a chain of coffee stores offering its new iced coffee beverage at 20% off through an electronic coupon and that was received from third-party remote device 106.

Block 606 causes the mobile device to present the shopping offer responsive to the mobile device being within one of the proximity thresholds. If the information indicates that mobile device 102 is within one of the proximity thresholds, remote manager 306 causes mobile device 102 to present the shopping offer immediately. If not, remote manager 306 provide the offers and, once the proximity threshold is determined to be met (locally at manager 210 or remotely at remote manager 306), the offer is presented. As noted above, the offer may include an identity of a brick-and-mortar store at which the offer can be redeemed, the proximity threshold (geographic or temporal), an electronic coupon, and other data.

Concluding the ongoing example, remote manager 306 causes manager 210 on mobile device 102 to present the two offers. Here assume that the offer from the small, private coffee shop is presented through user interface 212 and the offer from the chain of coffee stores is presented instead through one of third-party interface modules 220 associated with the chain of coffee stores. Mobile device 102 may present these at a same time, on a rotating basis, or by nearest-to-farthest store, for example.

In the above-described example the proximity threshold can be temporal or geographic, such as an amount of time to get to the store or a distance to the store, as noted elsewhere herein. In some cases, however, various dependencies may affect offers, such as business hours of a store at which an offer can be redeemed or how busy the store is. In such a case manager 210 or remote manager 306 may determine if the condition is met prior to presenting the offer, such as by checking the time or contacting an associated third party. Thus, an offer for half off an entrée at a restaurant may not be offered if the restaurant indicates, through third-party remote device 106 and prior to the offer being made, that it is fully occupied.

The preceding discussion describes methods relating to proximity-dependent shopping offers. Aspects of these methods may be implemented in hardware (e.g., fixed logic circuitry), firmware, software, manual processing, or any combination thereof A software implementation represents program code that performs specified offers when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices. Further, the features described herein are platform-independent and can be implemented on a variety of computing platforms having a variety of processors.

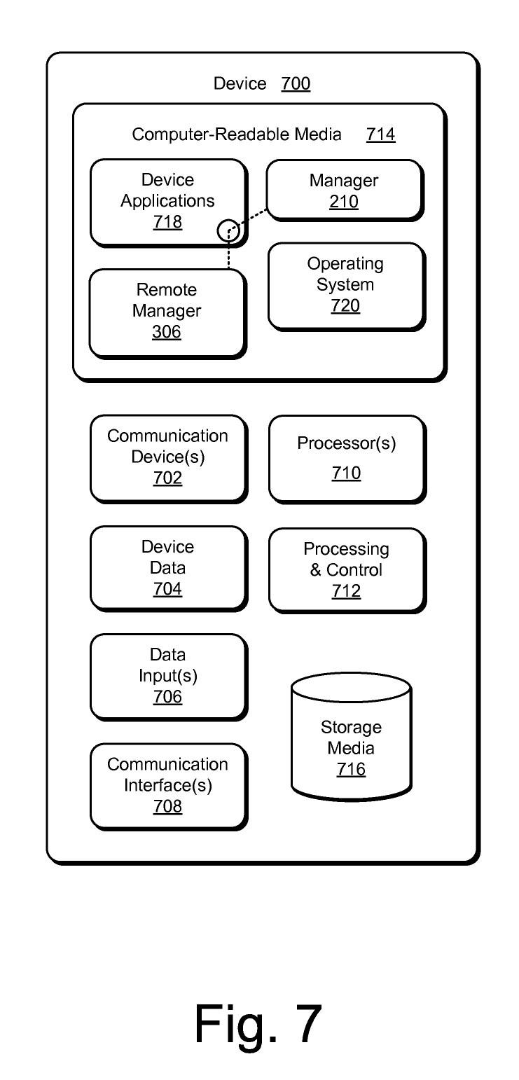

These techniques may be embodied on one or more of the entities shown in environment 100 of FIG. 1 including as detailed in FIG. 2 or 3, and/or example device 700 described below, which may be further divided, combined, and so on. Thus, environment 100 and/or device 700 illustrate some of many possible systems or apparatuses capable of employing the described techniques. The entities of environment 100 and/or device 700 generally represent software, firmware, hardware, whole devices or networks, or a combination thereof In the case of a software implementation, for instance, the entities (e.g., manager 210 and remote manager 306) represent program code that performs specified offers when executed on a processor (e.g., processor(s) 202 and/or 302). The program code can be stored in one or more computer-readable memory devices, such as media 302 and/or 304 or computer-readable media 714 of FIG. 7.

Example Device

FIG. 7 illustrates various components of example device 700 that can be implemented as any type of client, server, and/or computing device as described with reference to the previous FIGS. 1-6 to implement techniques enabling a proximity-dependent shopping offer. In embodiments, device 700 can be implemented as one or a combination of a wired and/or wireless device, as a form of television mobile computing device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 700 may also be associated with a user (e.g., a person) and/or an entity that operates the device such that a device describes logical devices that include users, software, firmware, and/or a combination of devices.

Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as human utterances, user-selectable inputs, messages, music, television media content, recorded video content, and any other type of audio, video, and/or image data received from any content and/or data source.

Device 700 also includes communication interfaces 708, which can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like), which process various computer-executable instructions to control the operation of device 700 and to enable techniques for proximity-dependent shopping offers. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable storage media 714, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable storage media 714 provides data storage mechanisms to store the device data 704, as well as various device applications 718 and any other types of information and/or data related to operational aspects of device 700. For example, an operating system 720 can be maintained as a computer application with the computer-readable storage media 714 and executed on processors 710. The device applications 718 may include a device manager, such as any form of a control application, software application, signal-processing and control module, code that is native to a particular device, a hardware abstraction layer for a particular device, and so on.

The device applications 718 also include any system components, engines, or modules to implement techniques enabling a proximity-dependent shopping offer. In this example, the device applications 718 can include manager 210 or remote manager 306.

Conclusion

Although embodiments of techniques enabling proximity-dependent shopping offers have been described in language specific to features and/or methods, it is to be understood that the subject of the appended claims is not necessarily limited to the specific features or methods described. Rather, the specific features and methods are disclosed as example implementations enabling proximity-dependent shopping offers.

What is claimed is:

1. A computer-implemented method comprising:
providing information, to a remote entity and through a communication network, about a user of a mobile device;
receiving a proximity-dependent shopping offer determined based on the information about the user, the proximity-dependent shopping offer associated with a brick-and-mortar store having a geographic location;
determining that the mobile device is proximate the geographical location; and
presenting, at the mobile device and responsive to determining that the mobile device is proximate the geographical location, the proximity-dependent shopping offer.

2. A computer-implemented method as described in claim 1, wherein the remote entity is associated with the brick-and-mortar store and the information indicates that the user has searched for, selected, or previously purchased a product similar or identical to an offered product of the proximity-dependent shopping offer and purchasable at the brick-and-mortar store.

3. A computer-implemented method as described in claim 1, wherein the proximity-dependent shopping offer includes a temporal proximity and determining that the mobile device is proximate the geographical location is based on a geographical proximity to the geographical location and a speed at which the mobile device is moving.

4. A computer-implemented method as described in claim 3, wherein determining the speed at which the mobile device is moving determines that the user is walking

5. A computer-implemented method as described in claim 3, wherein determining the speed at which the mobile device is moving determines that the user is driving and wherein determining that the mobile device is proximate the geographical location is based on automobile road conditions.

6. A computer-implemented method as described in claim 1, wherein the proximity-dependent shopping offer includes a temporal dependence based on business hours of the brick-and-mortar store, and determining that the mobile device is proximate the geographic location determines that the temporal dependence is met by determining that a current time is within the business hours.

7. A computer-implemented method as described in claim 1, wherein the proximity-dependent shopping offer includes a geographical proximity and determining that the mobile device is proximate the geographical location is based on a current location of the mobile device.

8. A computer-implemented method as described in claim 1, wherein presenting the proximity-dependent shopping offer:
determines that the proximity-dependent shopping offer is associated with an application on the mobile device; and
passes the proximity-dependent shopping offer to the application effective to enable the application to present, in a user interface tailored to the brick-and-mortar store, the proximity-dependent shopping offer.

9. A computer-implemented method as described in claim 1, further comprising presenting, at the mobile device and along with the proximity-dependent shopping offer, an estimated time to travel from a current location of the mobile device to the geographic location of the brick-and-mortar store.

10. A computer-implemented method comprising:
receiving, from a mobile device associated with a user, information about the user;
determining, based on the information about the user, a proximity-dependent shopping offer, the proximity-dependent shopping offer associated with one or more geographic locations having proximity thresholds; and
causing the mobile device to present the shopping offer responsive to the mobile device being within one of the proximity thresholds.

11. A computer-implemented method as described in claim 10, wherein the information indicates that the mobile device is within one of the proximity thresholds and causing the mobile device to present the shopping offer causes the mobile device to present the shopping offer immediately.

12. A computer-implemented method as described in claim 10, wherein determining the proximity-dependent shopping offer includes passing the information to a third party associated with a brick-and-mortar store at one of the geographic locations and receiving, from the third party, the proximity-dependent shopping offer.

13. A computer-implemented method as described in claim 10, wherein determining the proximity-dependent shopping offer further determines a temporal dependence for the proximity-dependent shopping offer, and where causing the mobile device to present the proximity-dependent shopping offer causes the mobile device to present the proximity-dependent shopping offer also responsive to the temporal dependence being met.

14. A computer-implemented method as described in claim 13, wherein the temporal dependence is based on business hours of a brick-and-mortar store at one of the geographic locations, the brick-and-mortar store capable of redeeming the proximity-dependent shopping offer.

15. A computer-implemented method as described in claim 10, wherein causing the mobile device to present the proximity-dependent shopping offer transmits, to the mobile device and through a communication network, the proximity-dependent shopping offer including an identity of a brick-and-mortar store at one of the geographic locations and the proximity threshold.

16. A computer-implemented method as described in claim 10, wherein the information includes:
search terms of a search performed on the mobile device, the search terms selected by the user;
brick-and-mortar purchases made through the mobile device; or
Internet-only purchases made through the mobile device.

17. A computer-implemented method as described in claim 10, wherein the information includes:
a current location of the mobile device; or
historical locations and accompanying times of the mobile device.

18. A computer-implemented method as described in claim 10, wherein the information includes a wish list of products selected by the user or a shopping cart of products purchased or selected and not purchased.

19. A computer-implemented method as described in claim 10, wherein the proximity-dependent shopping offer includes an electronic coupon.

20. A computer-implemented method comprising:
providing information, to a remote entity and through a communication network, indicating that a user of a mobile device has searched for, selected, or previously purchased a product;
receiving a proximity-dependent shopping offer determined based on the information, the proximity-dependent shopping offer offering an offered product similar or identical to the product indicated in the information, the proximity-dependent shopping offer associated with a brick-and-mortar store at which the offered product can be purchased;
determining that the mobile device is within a geographical proximity threshold of the brick-and-mortar store and within business hours of the brick-and-mortar store; and
presenting, through an application on the mobile device that is associated with the brick-and-mortar store and in a user interface tailored to the brick-and-mortar store, the proximity-dependent shopping offer.
